(19) United States
(12) Patent Application Publication
(10) Pub. No.: US 2010/0320056 A1
(43) Pub. Date: Dec. 23, 2010

(54) BILL ACCEPTOR THAT PREVENTS ARCHING OF EACH RECEIVED BILL

(75) Inventors: Cheng-Kang Yu, Taipei City (TW); Wei-Jr Chen, Taipei City (TW); Shih-Chia Chen, Taichung Hsien (TW)

Correspondence Address: Muncy, Geissler, Olds & Lowe, PLLC, 4000 Legato Road, Suite 310, FAIRFAX, VA, 22033, US

(73) Assignee: INTERNATIONAL CURRENCY TECHNOLOGIES CORPORATION, Taipei (TW)

(21) Appl. No.: 12/852,953

(22) Filed: Aug. 9, 2010

Related U.S. Application Data
(63) Continuation-in-part of application No. 12/058,761, filed on Mar. 31, 2008.

(51) Int. Cl. G07F 7/04; G07F 9/02

(52) U.S. Cl. 194/202; 194/206; 194/207

(57) ABSTRACT

A bill acceptor includes a bill acceptor main unit having a bill insertion slot, a bill transfer mechanism for transferring each inserted bill through a bill passage to a bill outlet, a bill recognition unit for recognizing the authenticity and value of each inserted bill and a bill pusher for pushing each inserted bill out of the bill outlet, and a bill box having a front opening facing the bill pusher, two elongated stop members disposed at two opposite lateral sides of the front opening in a parallel manner, a bill-receiving bearing board supported on spring members inside the box body of the bill acceptor for receiving each bill that is pushed away from the bill outlet into the bill box and a baffle pivotally mounted in the box body at the top side of front opening adjacent to the bill outlet and biasable for letting each inserted bill be pushed by the bill pusher out of the bill outlet onto the bill-receiving bearing board and reversible to hold down each received bill on the bill-receiving bearing board in a smooth condition to avoid bill jams.

This application is a Continuation-In-Part of application Ser. No. 12/058,761, filed on Mar. 31, 2008, now pending. The patent application identified above is incorporated here by reference in its entirety to provide continuity of disclosure.

### BACKGROUND OF THE INVENTION

1. Field of the Invention

The present invention relates to a bill acceptor and more specifically, to such a bill acceptor, which uses a spring-loaded baffle to hold down each received bill on a bill-receiving bearing board in a smooth condition, avoiding bill jams.

2. Description of the Related Art

Following fast development of technology, our mode of living has been changed, and different automatic vending machines are used everywhere to sell different products without serviceman. These automatic vending machines are highly invited for the advantage of saving much labor and bringing convenience to people.

Further, a Q-shop has the advantages of scientific intelligence, quick service, and quick finish of payment. A Q-shop may provide automatic vending machines for vending drinks, cigarettes, tickets, ice creams, tickets, memorial coins, key rings, or even hamburgers and noodles. Nowadays, many virtual shops are established to make online shopping, allowing shoppers to shop across millions of products.

Further, an automatic vending machine generally uses a bill acceptor to receive verify the authenticity and value of the inserted bill. An advanced bill acceptor has an insertion slot for the insertion of bill and license, and recognition means to identify the age of the license holder of the inserted license so that the automatic vending machine controls selling of controlled items.

Further, a bill acceptor uses a bill pusher to move each inserted bill away from the bill passage to the inside of the bill box, enabling all received bills to be kept in a stack on a bill-receiving bearing board inside the bill box. When the bill pusher plate of the bill pusher pushes a bill away from the bill passage toward the inside of the bill box, the two opposite side edges of the bill will be curved so that the bill can be moved through the gap between two stop members at two opposite lateral sides of the front opening of the box body. When the bill pusher plate is returned to its former position, the bill-receiving bearing board carrying the duly received bill will be forced forwards by spring members to stop the duly received bill against the inner walls of the two stop members. If the duly received bill is an old bill, the bill may be unable to return to a smooth condition. When the duly received bill is stopped by the bill-receiving bearing board against the inner walls of the stop members, the duly received bill may be squeezed to curve, causing the middle part of the duly received bill to be arched. The arched middle part of the duly received bill will interfere in the space of the rear end of the bill passage, hindering movement of a next bill from the bill passage into the front opening of the bill box. When this problem occurs, the bill acceptor will fail, and a troubleshooting is necessary, wasting much time and labor in inspection and maintenance.

Referring to FIGS. 12-14, a bill escrow/return device A according to U.S. Pat. No. 5,286,017 is provided which includes a bill escrow chamber A1 sized and positioned to receive a bill of a predetermined width, a bill pusher plate A2 reciprocally mounted for movement into and out of the bill escrow chamber A1, a bill stacker unit B for receiving the bill from the bill escrow chamber A1 by means of the pusher plate A2 upon confirmation of a vend transaction, and a bill return chute C for deposit of the bill upon cancellation of the vend transaction. The bill escrow chamber A1 has a first bill receiving area A11 for receiving the bill in a vertical orientation, a wing stop member B1 having an opening B10 therethrough sized to allow passage of the bill pusher plate A2, yet smaller in width than the width of the bill, a pair of wings B2 pivotally biased against the wing stop member B1, the wings B2 laterally spaced apart a distance slightly less than a width of the bill pusher plate A2 such that movement of the plate A2 against the wings B2 will cause the wings B2 to pivot and move away from the wing stop member B1, a second bill receiving area B11 defined between the wing stop member B1 and the wings B2, and a bill drive mechanism C for engaging and driving the bill from the second bill receiving area B11 to the bill return chute C1.

When a bill enters the first bill receiving area A11 of the bill escrow chamber A1 of the bill escrow/return device A, the bill pusher plate A2 is operated to push the bill into the second bill receiving area B11 between the wing stop member B1 and the wings B2 to bias the wings B2, causing two opposing sides of the bill to be stopped at the inner wall of the wing stop member B1. The bill pusher plate A2 will further push the bill from the second bill receiving area B11 into the bill stacker unit B for storage upon receipt of a transaction recognition message from the vending machine. If the bill escrow/return device A receives a transaction cancellation message, the bill drive mechanism C will return the bill from the second bill receiving area B11 to the bill return chute C1.

According to the aforesaid prior art design, the bill stacker unit B has a second bill receiving area B11 defined between a wing stop member B1 and wings B2 for deposit of a bill temporarily and for allowing return of the bill from the second bill receiving area B11 to the bill return chute C1 upon cancellation of the transaction. However, the structural characteristics and technical features of this prior art design cannot effectively eliminate the problem of arched bill that may lead to a bill jam.

A bill acceptor that cannot eliminate the problem of arched bill in the bill box may cause a bill jam problem. This kind of bill acceptor is not practical for use in a Q-shop.

Therefore, it is desirable to provide a bill acceptor with an improved structure of bill box that eliminates the aforesaid problem.

### SUMMARY OF THE INVENTION

The present invention has been accomplished under the circumstances in view. It is one object of the present invention to provide a bill acceptor for use in an automatic vending machine for receiving and verifying bills, which has means to hold down each received bill positively on a bill-receiving bearing board inside the bill box in a smooth condition, eliminating the problem of arched bill and avoiding bill jams.

To achieve this and other objects of the present invention, the bill acceptor comprises a baffle pivotally mounted in the box body of the bill box thereof at a top side of a front opening of the box body, and two torsion springs coupled between the baffle and the box body for reversing the baffle each time the baffle is biased by a bill that is pushed out of a bill outlet in the bill acceptor main unit of the bill acceptor by a bill pusher onto a bill-receiving bearing board in the box body of the bill acceptor. The baffle has a press portion suspending in the top side of the front opening of the box body of the bill acceptor on the middle. When one bill is pushed out of the bill outlet onto the bill-receiving bearing board by the bill pusher, the baffle is reversed to press the press portion on the middle part of the duly received bill, holding the duly received bill on the bill-receiving bearing board in a smooth condition without interfering in the open space of the bill outlet. Thus, each duly received bill will not interfere with the transfer of a next bill from the bill outlet into the box body, avoiding bill jams.

### BRIEF DESCRIPTION OF THE DRAWINGS

FIG. 1 is an elevational view of a bill acceptor in accordance with the present invention.

FIG. 2 is an exploded view of the bill acceptor shown in FIG. 1.

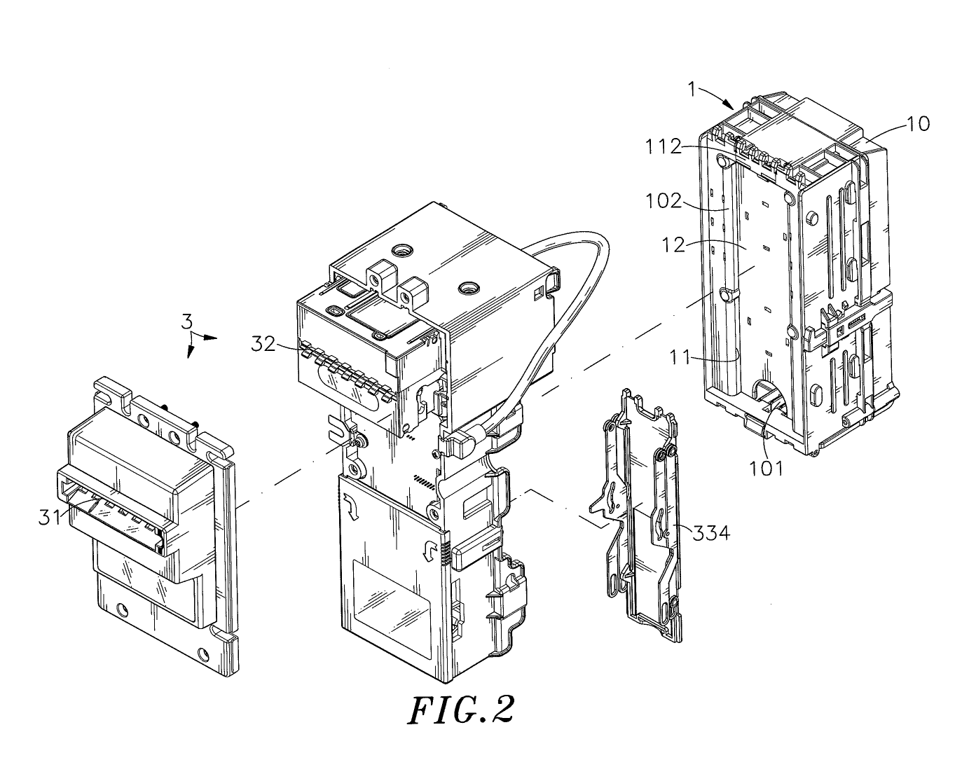

FIG. 3 is a sectional side view of the bill acceptor shown in FIG. 1.

FIG. 4 is in an enlarged view of a part of FIG. 3.

FIG. 5 is an exploded view of the bill box of the bill acceptor shown in FIG. 1.

FIG. 6 is a partial sectional view of the bill acceptor in accordance with the present invention.

FIG. 7 is a sectional elevation of a part of the present invention, showing an operation status of the bill acceptor (I).

FIG. 8 is a sectional elevation of a part of the present invention, showing an operation status of the bill acceptor (II).

FIG. 9 is a sectional elevation of a part of the present invention, showing an operation status of the bill acceptor (III).

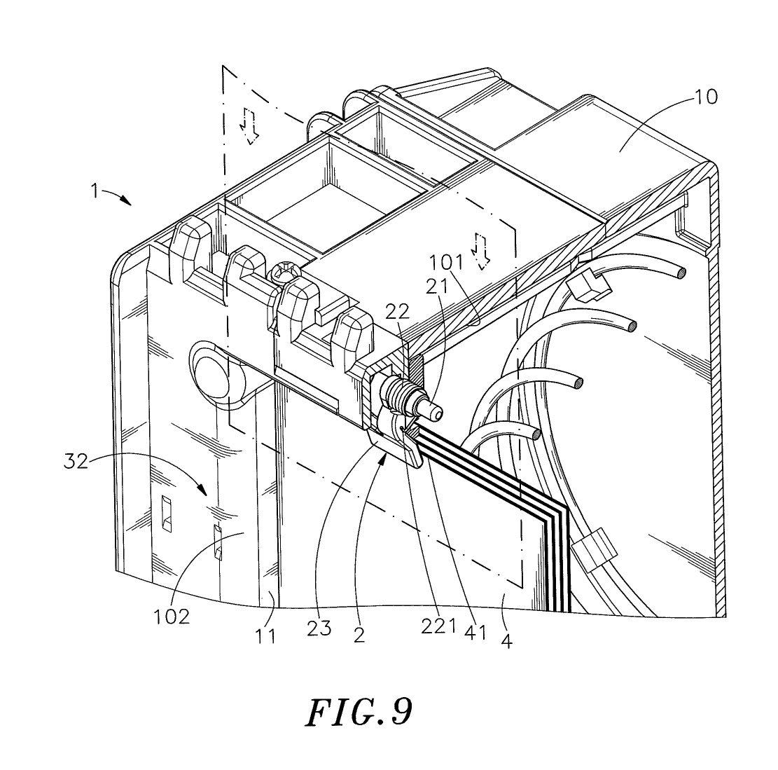

FIG. 10 is a partial sectional view of the bill acceptor in accordance with the present invention, showing a number of bills stacked in the bill chamber of the box body of the bill box of the bill acceptor (I).

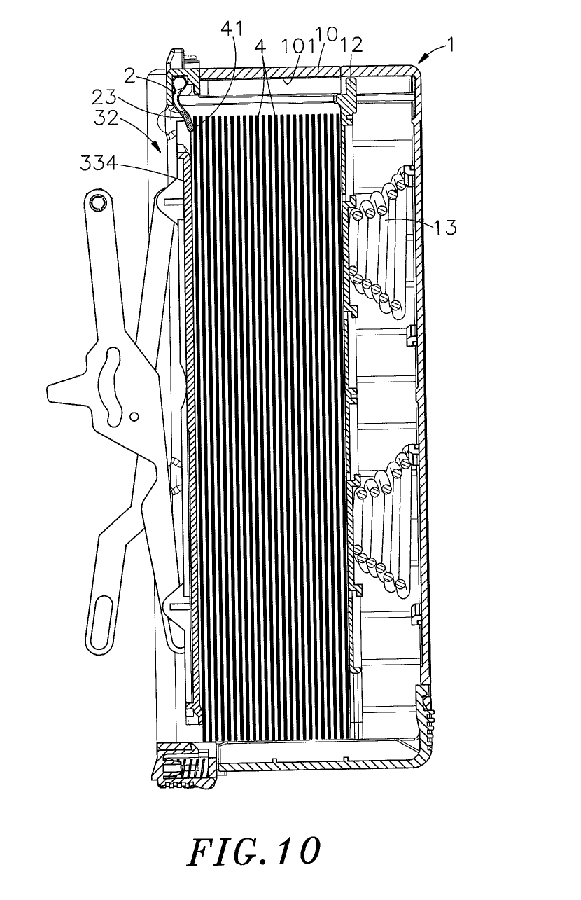

FIG. 11 is a partial sectional view of the bill acceptor in accordance with the present invention, showing a number of bills stacked in the bill chamber of the box body of the bill box of the bill acceptor (II).

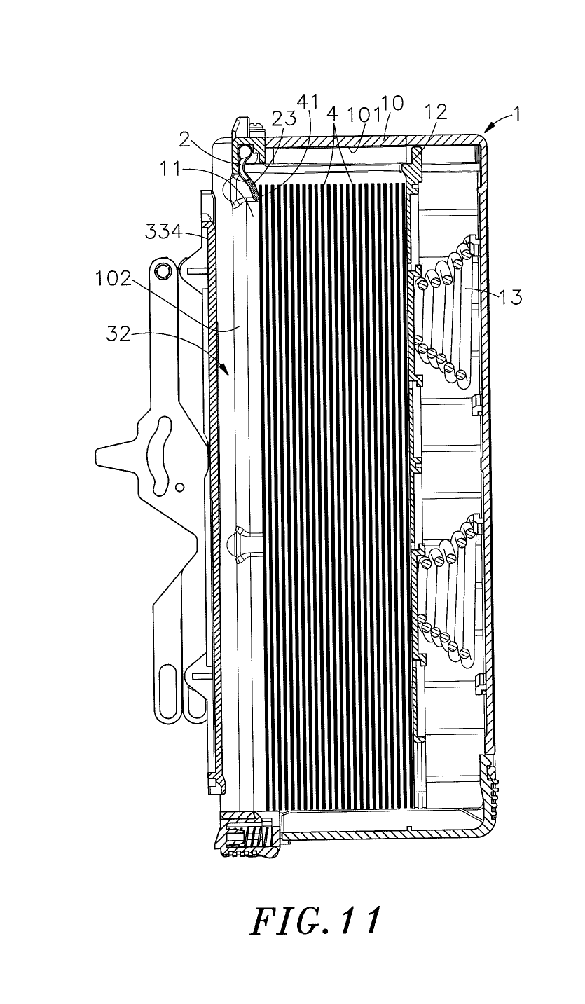

FIG. 12 is sectional side view of a bill escrow/return device according to the prior art.

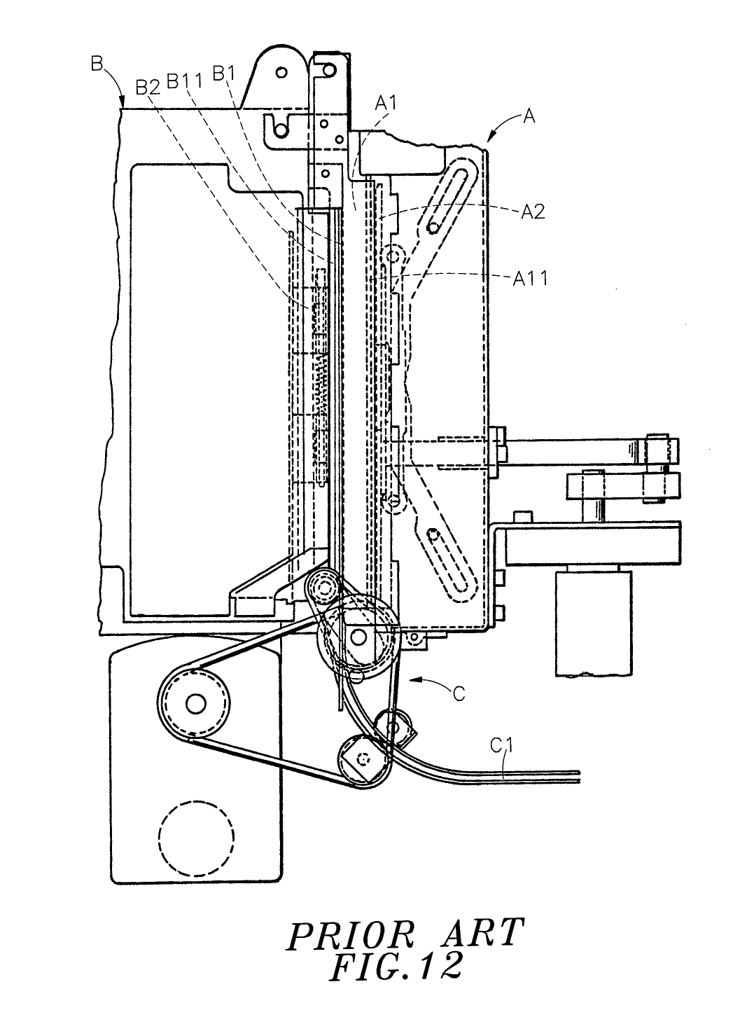

FIG. 13 is a schematic front view of the bill escrow/return device according to the prior art.

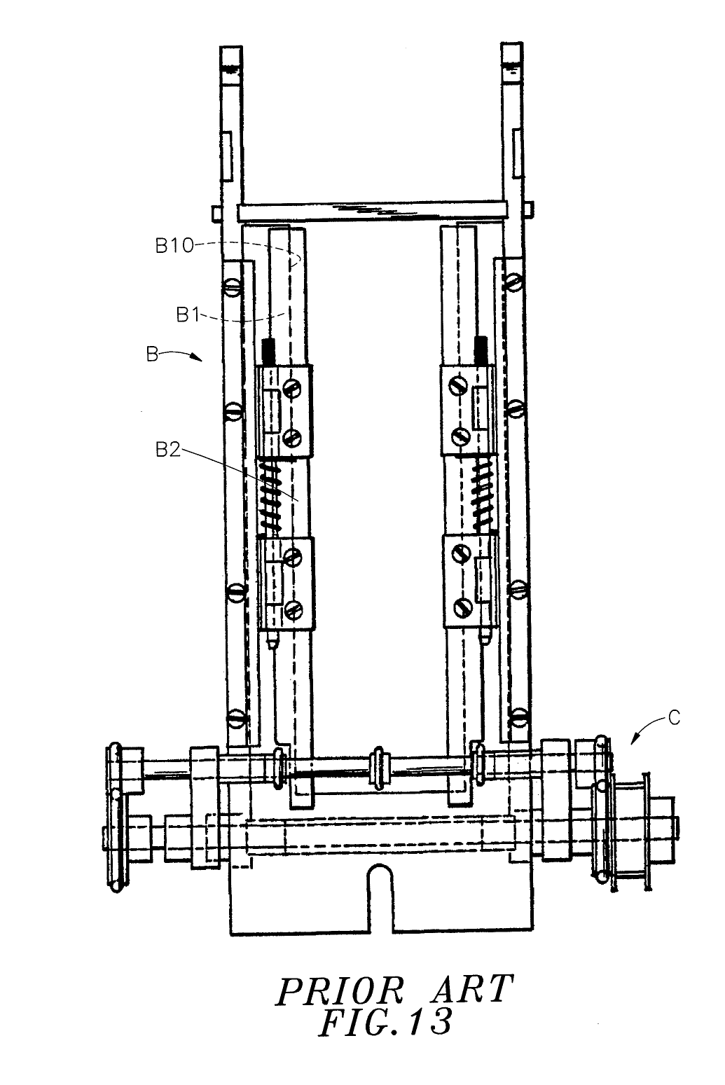

FIG. 14 is a schematic top view of a part of the bill escrow/return device according to the prior art.

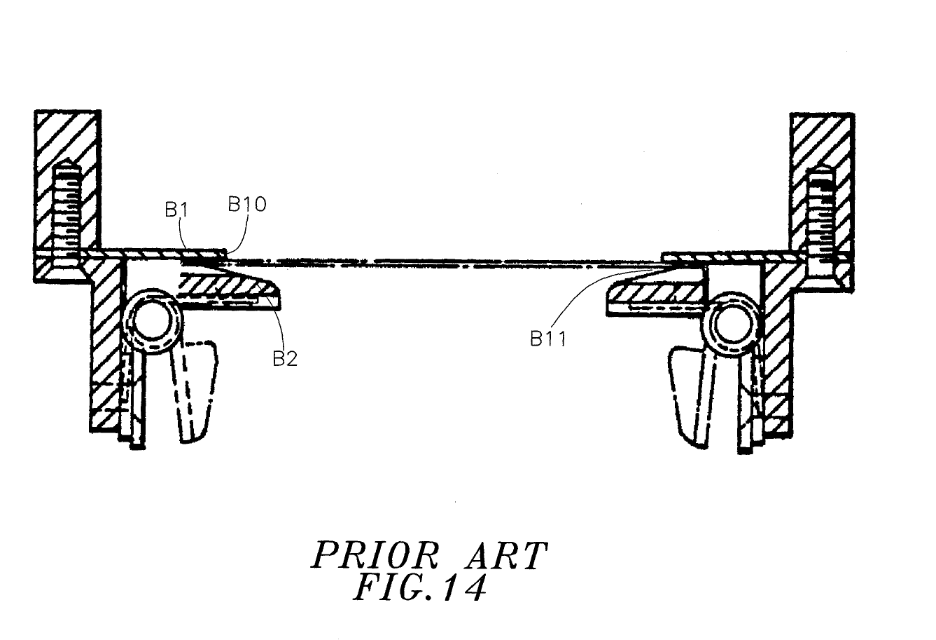

### DETAILED DESCRIPTION OF THE PREFERRED EMBODIMENT

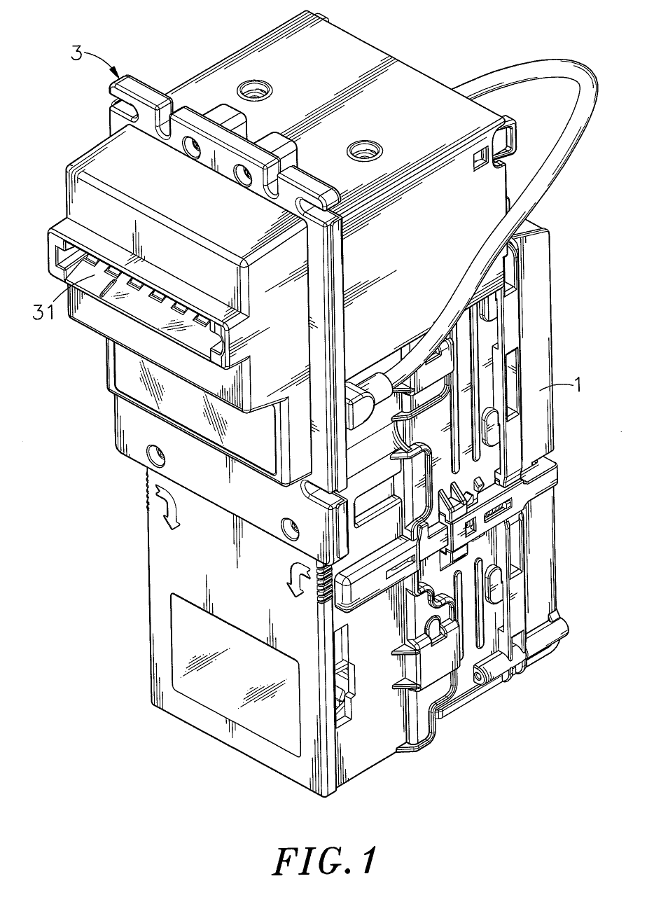

Referring to FIGS. 1˜5, a bill acceptor in accordance with the present invention is shown comprising a bill acceptor main unit 3 and a bill box 1 installed in the main unit 1. The bill box 1 is equipped with a baffle 2 for stopping each receiving bill 4 against curving.

The bill box 1 comprises a box body 10, a bill chamber 101 defined in the box body 11, a front opening 11 through which a bill can be pushed into the inside of the bill chamber 101, two elongated stop members 102 respectively disposed at two opposite lateral sides of the front opening 11 and spaced from each other a distance slightly shorter than the width of each bill to be received in the bill chamber 101, a bill-receiving bearing board 12 suspending inside the bill chamber 101 and movable forwards and backwards relative to the front opening 11 (elongated stop members 102), and spring members 13 that support the bill-receiving bearing board 12 in the bill chamber 101 and impart a pressure to the bill-receiving bearing board 12 toward the front opening 11 (elongated stop members 102). The bill-receiving bearing board 12 has a width slightly greater than the distance between the two elongated stop members 101 so that the bill-receiving bearing board 12 can be stopped against the inner walls of the elongated stop members 101. The box body 11 further comprises a locating groove 111 on the top side of the front opening 11, and a locating block 112 mounted in the locating groove 111. The locating block 112 has two pivot holes 1121 aligned in line.

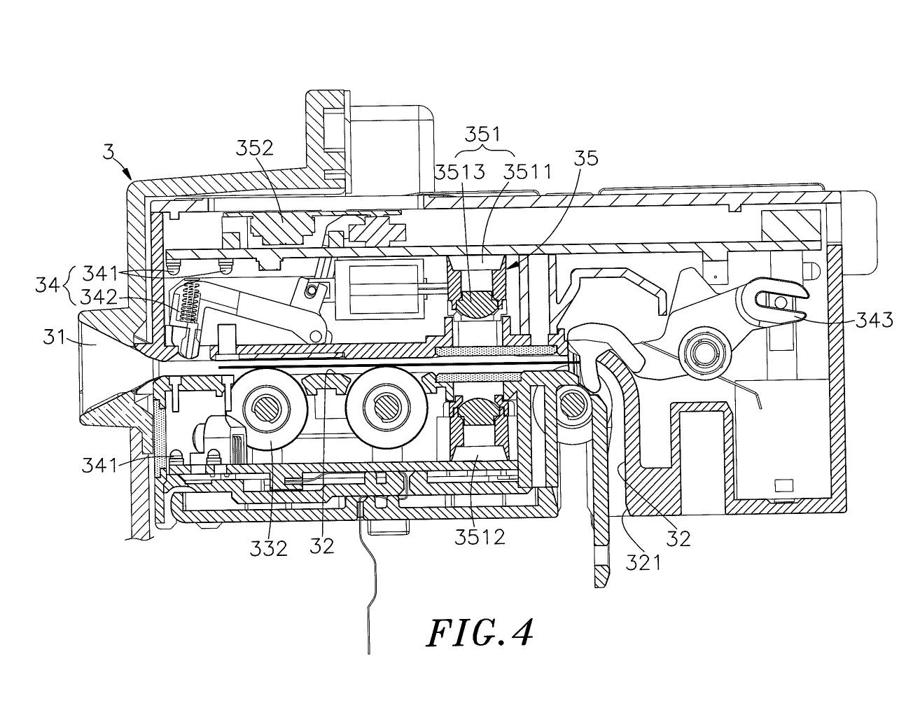

The baffle 2 has two pivot pins 21 respectively pivoted to the pivot holes 1121 of the locating block 112 (see FIG. 4). Two torsional springs 22 are respectively mounted on the pivot pins 21, each having two opposite ends 221 respectively fastened to the bottom side of the locating block 112 and the baffle 2. The baffle 2 has a press portion 23 projecting into the the front opening 11 of the box body 10. The torsional springs 22 impart a pressure to the baffle 2, forcing the press portion 23 against the surface of the bill-receiving bearing board 12.

The bill acceptor main unit 3 comprises a bill insertion slot 31, a bill passage 32 extending backwardly from the bill insertion slot 31, a bill transfer mechanism 33 arranged at two sides relative to the bill passage 32 and adapted for transferring each inserted bill 4 from the bill insertion slot 31 through the bill passage 32 to the rear end of the bill passage 32. The bill transfer mechanism 33 comprises a motor 331, a set of bill-transfer rollers 332, a bill-transfer belt 333, and a bill pusher 334 that suspends in one side of a bill outlet 321 at the rear end of the bill passage 32. The bill pusher 334 has a width slightly shorter than the distance between the two elongated stop members 101 so that the bill pusher 334 can push each inserted bill 4 out of the bill outlet 321 at the rear end of the bill passage 32 through the front opening 11 of the box body 10 into the bill chamber 101.

Further, an encoder wheel 3311 and an optical sensor 3312 are arranged in the bill acceptor main unit 3 and adapted for counting the number of turns of the bill-transfer rollers 332 that is indicative of the revolving speed of the bill-transfer rollers 332. The bill acceptor bill acceptor main unit 3 comprises a start-up device 34 disposed around the front side of the bill passage 32, and a recognition unit 35 disposed at top and bottom sides relative to the bill passage 32 (see FIG. 4). The star-up device 34 comprises a plurality of sensor switches 341, a light-shielding gate 342, and an anti-theft hook 343. The recognition unit 35 comprises an optical recognition module 351. The optical recognition module 351 comprises a plurality of light emitting devices 35111, a plurality of optical sensors 3512 respectively axially aimed at the light emitting devices 35111, and lenses 3513 respectively set between the light emitting devices 35111 and the optical sensors 3512 near the bill passage 32.

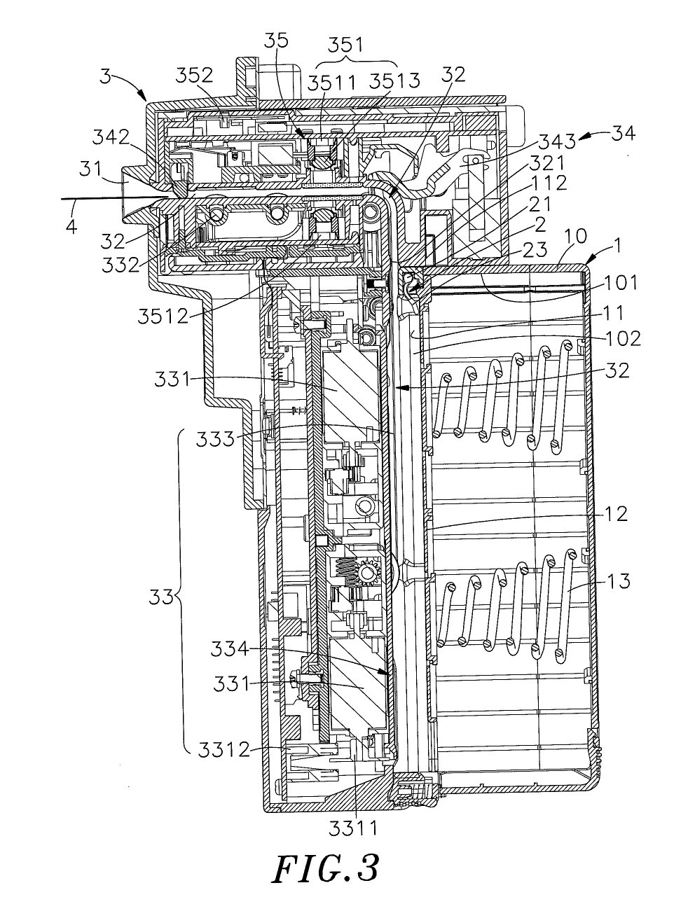

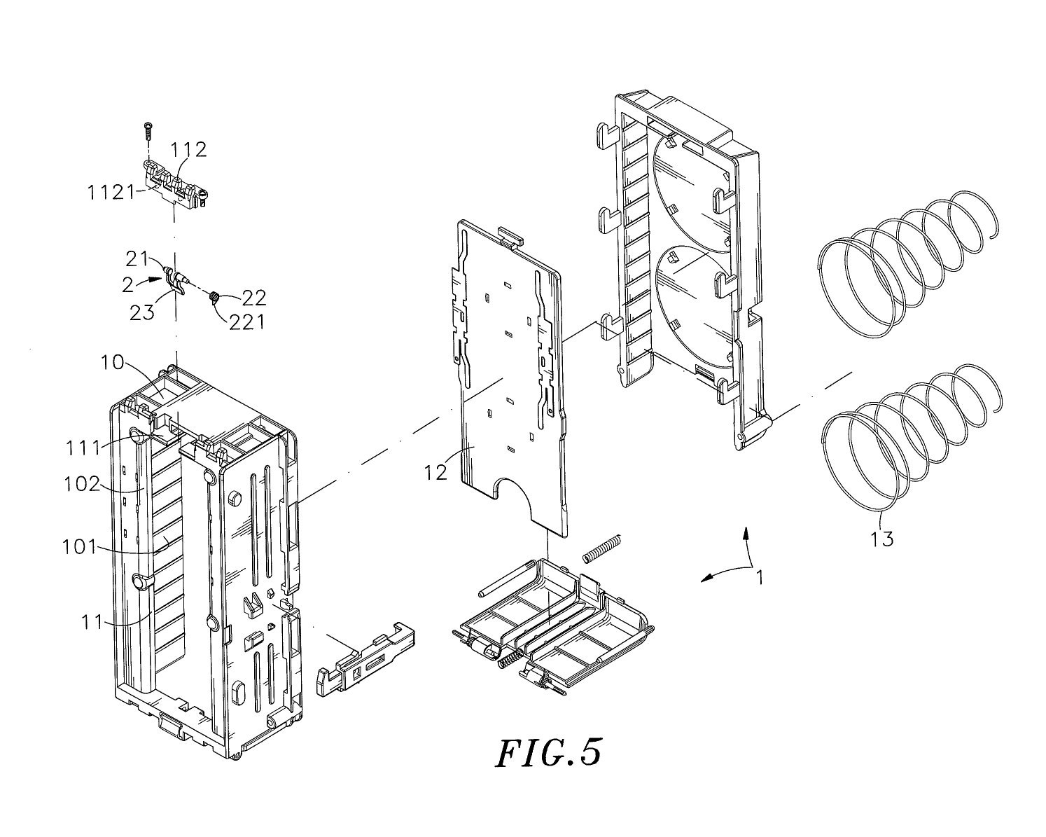

Referring to FIGS. 3-5 again, the bill acceptor main unit 3 and the bill box 1 are fastened together, forming a bill acceptor that is then installed in an automatic vending machine. When a user inserts a bill 4 through the bill insertion slot 31 of the bill acceptor main unit 3 into the bill passage 32, the inserted bill 4 shields the sensor switches 341, causing the sensor switches 341 to drive the light-shielding gate 342, the bill transfer mechanism 33 and the recognition unit 35. When the light-shielding gate 342 is opened, the bill 4 can then be inserted into the bill passage 32. At this time, the motor 331 of the bill transfer mechanism 33 is started to move the bill-transfer rollers 332 and the bill-transfer belts 333, carrying the inserted bill 4 forwards. When the bill 4 passed over the light-shielding gate 342, the sensor switches 341 immediately close the light-shielding gate 342, starting anti-theft functioning and avoiding interference of external light with the recognition functioning of the recognition unit 35.

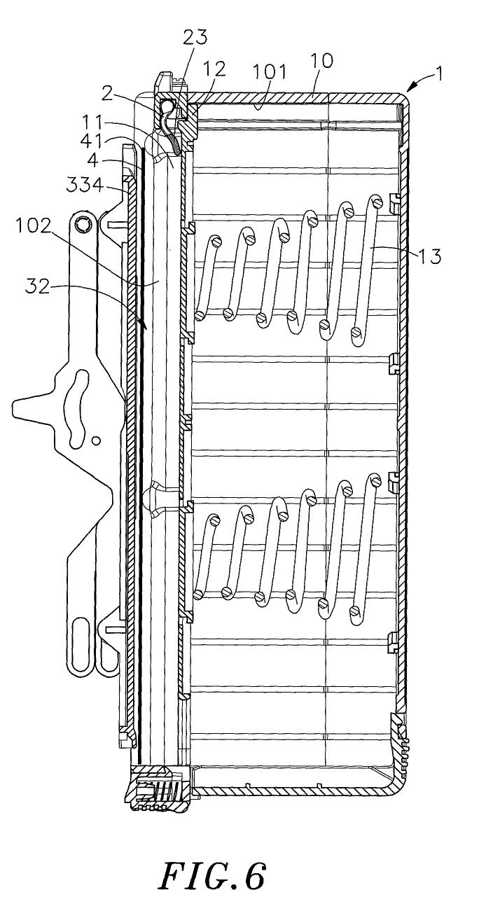

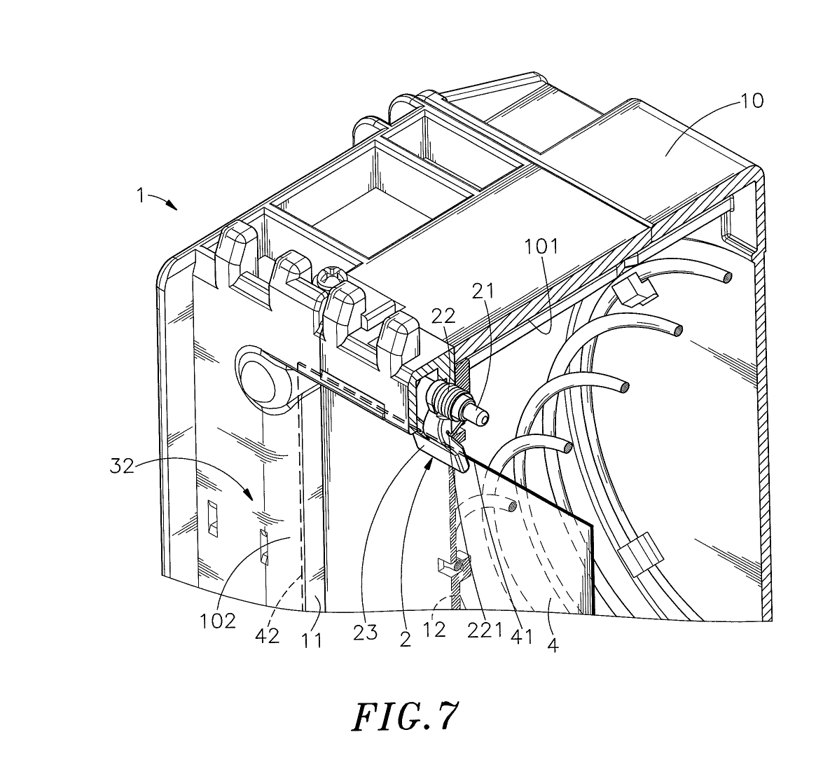

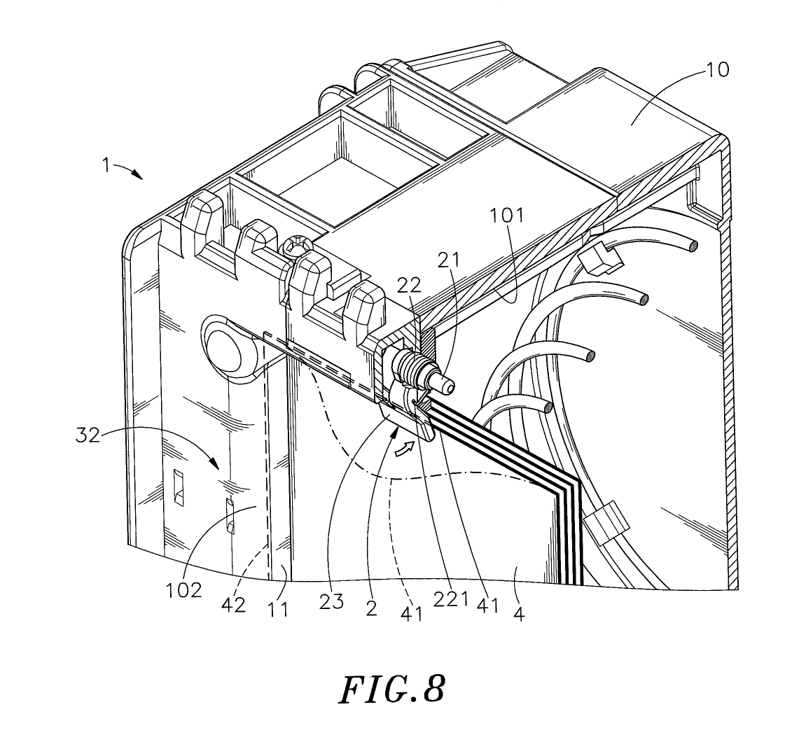

When the inserted bill 4 is recognized by the recognition unit 35 to be true, the bill transfer mechanism 33 is started to transfer the bill 4 toward the rear end of the bill passage 32. When the bill 4 is moved through the bill outlet 321 to the gap between the bill pusher 334 and the box body 10 of the bill box 1 (see FIGS. 1, 6 and 7), the bill pusher 334 is driven to push the bill 4 away from the bill passage 32 through the front opening 11 of the box body 10 over the elongated stop members 102 and the baffle 2 toward the inside of the bill chamber 101 and to press the bill 4 against the bill-receiving bearing board 12, forcing the bill 4 and the bill-receiving bearing board 12 toward the inside of the bill chamber 101 against the spring members 13. When the bill 4 is being moved over the baffle 2, the bill 4 will touch the press portion 23 of the baffle 2, causing the pivot pins 21 of the baffle 2 to be rotated relative to the pivot holes 1121 of the locating block 112. When the bill 4 passed over the elongated stop members 102, the bill pusher 334 is returned to its former position, enabling the bill-receiving bearing board 12 to be forced forwards by the spring members 13 to stop the received bill against the inner walls of the elongated stop members 102, and at the same time, the baffle 2 is revered by the torsional springs 22 to press the press portion 23 on the middle part 41 of the bill 4 against the bill-receiving bearing board 12 (see FIGS. 8˜11), keeping the bill 4 in a smooth condition without interfering in the open space of the bill outlet 321. Thus, the bill or bills 4 received at the bill-receiving bearing board 12 does not interfere with the transfer of a next bill from the bill outlet 321 into the bill chamber 101, facilitating stacking of bills 4 in the box body 10 and avoiding bill jams.

Referring to FIGS. 3 and 4 again, by means of using the encoder wheel 3311 and an optical sensor 3312 to count the number of turns of the bill-transfer rollers 332 during operation, the motor 331 of the bill transfer mechanism 33 of the bill acceptor main unit 3 is accurately controlled, and therefore the bill transfer mechanism 33 can transfer each inserted bill 4 to a predetermined location accurately for enabling the recognition unit 35 to verify the authenticity and value of each inserted bill 4. During verification, the light-emitting devices 3511 of the optical recognition module 351 emit light through the bill 4 toward the optical sensors 3512, and the optical sensors 3512 receive the light penetrated through the bill 4, and therefore the transmission of the light is measured and compared to reference data for determining the authenticity and value of the bill 4. The light-emitting devices 3511 can be prepared to emit different wavelengths of visible light (blue light, green light, red light, etc.) or invisible (ultraviolet light) so that the recognition unit 35 can recognize the authenticity and value of different bills 4 issued in different countries.

Further, the bill pusher 334 can be formed of a bill-pushing board, cross-linking mechanism, or any other designs capable of pushing each inserted bill 4 away from the bill passage 32 toward the inside of the bill box 1. Because the bill pusher 334 can easily be achieved by means of conventional techniques, no further detailed description in this regard is necessary.

The aforesaid recognition unit 35 further comprises at least one sampling module 352 arranged at a back side relative to the sensor switches 341. The sampling module 352 is adapted for reading and identifying anti-counterfeit characteristics and character data of a license inserted into the bill acceptor main unit 3. By means of using the sampling module 352 to recognize the date of birth, name of the license holder of the license and the identification number or license number of the license, the bill acceptor can be used in an automatic vending machine for selling controlled items.

Further, the license photographing and related data recording function of the bill acceptor can be used with street video surveillance and security cameras to constitute a perfect criminal search network, helping the police to combat crime.

Further, the aforesaid sampling module 352 comprises an image sensor adapted to pick up the image of the anti-counterfeit characteristics of an inserted license or bill. The image sensor can be a charge coupled device (CCD), complementary metal-oxide semiconductor (CMOS) image sensor, or any suitable type image sensor. The anti-counterfeit characteristics include watermarking, steel stamp, invisible barcode, laser label, and etc.

Further, the bill insertion slot 31 and bill passage 32 of the bill acceptor main unit 3 allow insertion of a bill 4 as well as a license. The bill transfer mechanism 33 of the bill acceptor main unit 3 is controllable to transfer each inserted bill 4 or license inwards toward the bill box 1. The bill transfer mechanism 33 of the bill acceptor main unit 3 is also controllable to transfer each inserted bill 4 or license in the revered direction to the bill insertion slot 31 when the inserted bill 4 or license is checked to be a counterfeit. Further, because the bill acceptor main unit 3 uses simply only one single insertion slot 31, one bill passage 32 and one single bill transfer mechanism 33 for receiving and transferring licenses and bills, the manufacturing cost of the bill acceptor is greatly lowered.

By means of the exclusive single bill passage 32 for bill as well as license, the user must retrieve the inserted license before insertion of a bill 4, preventing the problem that the user forgets to take back the inserted license.

As indicated above, the box body 10 of the bill box 1 has a front opening 11 facing the bill pusher 334 of the bill acceptor main unit 3, and a baffle 2 pivotally mounted in one side of the front opening 11 adjacent to the bill outlet 321. The baffle 2 has a press portion 23 suspending in the front opening 11 adjacent to the bill outlet 321. After an inserted bill 4 is moved by the bill pusher 334 to the bill-receiving bearing board 12, the baffle 2 is forced by torsional springs 22 to press the press portion 23 on the middle part 41 of the received bill 4 against the bill-receiving bearing board 12, holding bill 4 positively on the bill-receiving bearing board 12 in a smooth condition, avoiding interference of each received bill with the transfer of a next bill to be transferred from the bill outlet 321 into the bill chamber 101 and facilitating stacking of received bills 4 in the box body 10.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising:
a bill acceptor main unit, said bill acceptor main unit comprising a bill insertion slot for the insertion of a bill, a bill passage extending backwardly from said bill insertion slot and terminating in a bill outlet, a bill transfer mechanism adapted for transferring each inserted bill from said bill insertion slot through said bill passage to said bill outlet, a recognition unit adapted for recognizing the authenticity and value of each inserted bill, a start-up device adapted for sensing insertion of a bill into said bill insertion slot and starting up said bill transfer mechanism and said bill recognition unit, and a bill pusher adapted for pushing an inserted bill out of said bill outlet; and
a bill box fastened to said bill acceptor main unit corresponding to said bill pusher, said bill box comprising a box body, said box body having a front opening facing said bill pusher and a bill chamber in communication with said front opening for receiving each inserted bill from said bill outlet, two elongated stop members mounted in said box body and respectively disposed at two opposite lateral sides of said front opening in a parallel manner, each said elongated stop member having an inner wall, a bill-receiving bearing board suspending inside said box body and movable forwards/backwards relative to said front opening for receiving each inserted bill being pushed by said bill pusher out of said bill outlet into said bill chamber and stopping each received bill against the inner walls of said elongated stop members, and a baffle pivotally mounted in said box body at one side of said front opening adjacent to said bill outlet and equally spaced between said elongated stop members and biasable for letting each inserted bill be pushed by said bill pusher out of said bill outlet onto said bill-receiving bearing board and reversible to hold down each inserted bill on said bill-receiving bearing board in a smooth condition after the bill has been pushed by said bill pusher out of said bill outlet onto said bill-receiving bearing board.

2. The bill acceptor as claimed in claim 1, wherein said baffle comprises two pivot pins axially aligned in line and pivotally connected to said box body, a press portion connected between said pivot pins and suspending in said front opening of said box body adjacent to said bill outlet, and two torsion springs respectively sleeved onto said pivot pins for reversing said pivot pins.

3. The bill acceptor as claimed in claim 2, wherein each said torsion spring has two opposite ends respectively connected to said press portion of said baffle and said box body.

4. The bill acceptor as claimed in claim 2, wherein said comprises a locating groove located on a top side of said front opening, and a locating block mounted in said locating groove for supporting said baffle.

5. The bill acceptor as claimed in claim 4, wherein said locating block comprises two pivot holes aligned in line; the two pivot pins of said baffle are respectively pivotally connected to the two pivot holes of said locating block; each said torsion spring has two opposite ends respectively connected to said press portion of said baffle and said locating block of said box body.

6. The bill acceptor as claimed in claim 2, wherein said press portion of said baffle suspends in said front opening of said box body and slopes in direction toward said bill chamber.

7. The bill acceptor as claimed in claim 1, wherein said bill box further comprises a plurality of spring members mounted inside said bill chamber to support said bill-receiving bearing board in said bill chamber and adapted to impart a pressure to said bill-receiving bearing board toward said front opening.

8. The bill acceptor as claimed in claim 1, wherein said start-up device is an optically triggered or mechanically controlled device.

9. The bill acceptor as claimed in claim 1, wherein said start-up device comprises a plurality of sensor switches, a light-shielding gate controllable by said sensor switches to close/open said bill passage.

10. The bill acceptor as claimed in claim 1, wherein said start-up device comprises an anti-theft hook set in said bill passage.

11. The bill acceptor as claimed in claim 1, wherein said bill transfer mechanism comprises a motor, a plurality of bill-transfer rollers rotatable by said motor, a bill-transfer belt mounted round said bill-transfer rollers for carrying each inserted bill, and an encoder and optical sensor means adapted for counting the revolving speed of said bill-transfer rollers and controlling the operation of said motor subject to counting.

12. The bill acceptor as claimed in claim 1, wherein said recognition unit comprises an optical recognition module, said optical recognition module comprising a plurality of light emitting devices arranged at one side relative to said passage and a plurality of optical sensors arranged at an opposite side relative to said passage and respectively aimed at said light emitting devices.

13. The bill acceptor as claimed in claim 1, wherein said recognition unit further comprises at least one sampling module adapted for reading and identifying anti-counterfeit characteristics and character data of a license inserted by a user into said insertion slot of said bill acceptor main unit.
